(19) United States
(12) Patent Application Publication
(10) Pub. No.: US 2012/0323376 A1
(43) Pub. Date: Dec. 20, 2012

(54) AIR CONDITIONING CONTROLLING DEVICE AND METHOD

(75) Inventors: Mituhiro HONDA, Tokyo (JP); Kazuya HARAYAMA, Tokyo (JP)

(73) Assignee: AZBIL CORPORATION

(21) Appl. No.: 13/523,578

(22) Filed: Jun. 14, 2012

(30) Foreign Application Priority Data
Jun. 14, 2011 (JP) 2011-131995

(51) Int. Cl. G05D 23/00

(52) U.S. Cl. 700/276

(57) ABSTRACT

In an operating quantity calculating portion, an operating quantity controlling an air-conditioned space to a target air-conditioning environment is calculated for each individual air-conditioning equipment through performing CFD reverse analysis on the air-conditioning environment of the air-conditioned space; in a state estimating portion, state setting values indicate the state of the target air-conditioning environment at the measurement locations of the individual sensors provided in the air-conditioned space are estimated respectively through CFD forward analysis on these operating quantities; and, in a feedback controlling portion, a coordinating factor is calculated based on the deviations between the state setting values obtained and the state measured values that are measured by the sensors, where coordinated operating quantities are calculated through correcting each of the operating quantities by the coordinating factor, and coordinated feedback control of the air-conditioning equipment is performed through sending, to the air-conditioning system, the individual coordinated operating quantities thus obtained.

### CROSS REFERENCE TO RELATED APPLICATIONS

The present application claims priority under 35 U.S.C. §119 to Japanese Patent Application No. 2011-131995, filed Jun. 14, 2011, which is incorporated herein by reference.

### FIELD OF TECHNOLOGY

The present invention relates to an air conditioning controlling technology, and, in particular, relates to an air conditioning controlling technology for controlling a conditioning environment in a target location within a space.

### BACKGROUND

When maintaining a space in a desired existing environment, not only is air conditioning equipment installed in the air-conditioned space for which air conditioning is to be performed, but also temperature sensors are disposed at locations that are representative of areas of the air-conditioned space, and operating quantities for the airflow speed, the airflow direction, the temperature, and the like, of the conditioned air that is provided from the air conditioning equipment are determined in accordance with the outputs of the temperature sensors.

Moreover, in the case of a large area, such as an office, one may consider a situation wherein the large air space is partitioned and wherein there are multiple single-loop feedback control systems, for each air-conditioned area that is provided.

However, in an office, for example, when it comes to the placement of people, lighting, electronic equipment, and the like that act as heat sources, and the placement of desks, chairs, partitions, and the like that become obstructions to the airflow, typically the priority is on efficiency in the work operations, and thus this type of office layout is not designed with a priority on air conditioning control. Because of this, inevitably there will be strong “thermal interferences” when it comes to the positional relationships between the vents of the air conditioning facilities and the temperature sensors.

Consequently, in an implementation that is structured from a plurality of single-loop feedback control systems, it is difficult to stabilize the operating quantities due to this type of thermal interference, making optimal control difficult. For example, when the magnitude of the change in temperature when moving to the desired air conditioning environment is large, there will be fluctuations in the state of control, and the operating quantities will be unstable because of mismatched operations wherein each of the feedback systems is individually searching for a stable state within the system as a whole.

In this regard, conventionally there have been proposals for air-conditioning controlling technologies for controlling the air-conditioning environment in a target location within an air space using a distributed system heat flow analysis technique (See, for example, HARAYAMA, Kazuya; HONDA, Mitsuhiro; and KASEDA, Choseihara [SIC—“Chosei”]: “Development of a Thermal Environment Controlling Technology for an Arbitrary Space within a Room, Using a Distributed-System Simulation,” 2010 Conference, I-20, The Society of Heating, Air-Conditioning, and Sanitary Engineers of Japan, Sep. 1, 2010). In this technique, the initial air-conditioned states in the applicable air-conditioned spaces are analyzed sequentially to estimate distribution data that indicates the distribution of the temperatures and air flows within the air-conditioned spaces, and reverse analysis is performed for the distribution data and the target temperatures in the target locations in order to estimate new operating quantities pertaining to the air-conditioning control, where the blowing speeds and blowing temperatures at the blowing apertures for the individual air-conditioning equipment that are provided within the air-conditioned space are calculated based on the new operating quantities. Also see, Japanese Patent 4016066.

However, in such a conventional technology there has been a problem in that it has not been possible to obtain good responsiveness due to the time required for the temperature of the target location to achieve the target temperature.

As described above, when new operating quantities pertaining to the air-conditioning control are estimated through reverse analysis of the distribution data and the target temperatures at the target locations, the operating quantities obtained indicate static operating quantities in a state wherein the temperature at the target location has achieved the target temperature. Because of this, when controlling the individual air-conditioning equipment by the blowing speeds and blowing temperatures calculated from such operating quantities, the target locations will achieve the target temperatures, but the time required to achieve the target temperatures will be long.

The examples of the present invention solve such a problem as set forth above, and the object thereof is to provide an air-conditioning controlling technique that provides excellent responsiveness even when calculating the operating quantities for controlling the air-conditioned space to the target air conditioning environment using the distributed system flow analysis technique.

### SUMMARY

In order to achieve this object, the air-conditioning controlling device according to the examples of the present invention is an air-conditioning controlling device for sending to an air-conditioning system, which controls air-conditioning equipment that is provided in an air-conditioned space, operating quantities for the air-conditioning equipment, to control the air-conditioned space to an arbitrary air-conditioning environment, including an operating quantity calculating portion for calculating, for each individual air-conditioning equipment, an operating quantity for controlling the air-conditioned space to the target air-conditioning environment, through performing distributed system flow analysis of the air-conditioning environment within the air-conditioned space based on condition data that indicate the structure of the air-conditioned space and effects on the air-conditioning environment within the air-conditioned space, and target data that indicate a target value at a target location within the air-conditioned space under the target air-conditioning environment; a state estimating portion for estimating respective state setting values that indicate the state of the target air-conditioning environment in the measurement locations of the individual sensors that are provided within the air-conditioned space, through distributed system flow forward analysis of the operating quantities obtained by the state estimating portion; and a feedback controlling portion for coordinating the air-conditioning equipment to perform feedback control through calculating a coordinating factor for coordinating and correcting individual operating quantities based on deviations between state setting values, estimated by the state estimating portion, and state measured values, measured by the sensors, for calculating coordinated operating quantities through correcting the individual operating quantities, obtained from the operating quantity calculating portion, by the coordinating factor, and for sending, to the air-conditioning system, the individual coordinated operating quantities thus obtained.

In this case, the feedback controlling portion may calculate a new operating quantity corresponding to a deviation based on air-conditioning control characteristics, set in advance, that indicate the relationship between a deviation and an operating quantity difference, and calculates, as the coordinating factor, a factor for converting the operating quantity to the new operating quantity.

Moreover, the feedback controlling portion may calculate an individual coordinating factors for each individual sensor, and calculates the coordinating factor that is shared by each of the sensors through performing a statistical process on the individual factors.

Moreover, an air-conditioning controlling method according to the examples of the present invention is an air-conditioning controlling method for sending to an air-conditioning system, which controls air-conditioning equipment that is provided in an air-conditioned space, operating quantities for the air-conditioning equipment, to control the air-conditioned space to an arbitrary air-conditioning environment, wherein: an operating quantity calculating portion has an operating quantity calculating step for calculating, for each individual air-conditioning equipment, an operating quantity for controlling the air-conditioned space to the target air-conditioning environment, through performing distributed system flow analysis of the air-conditioning environment within the air-conditioned space based on condition data that indicate the structure of the air-conditioned space and effects on the air-conditioning environment within the air-conditioned space, and target data that indicate a target value at a target location within the air-conditioned space under the target air-conditioning environment; a state estimating portion has a state estimating step for estimating respective state setting values that indicate the state of the target air-conditioning environment in the measurement locations of the individual sensors that are provided within the air-conditioned space, through distributed system flow forward analysis of the operating quantities obtained by the state estimating portion; and a feedback controlling portion has a feedback controlling step for coordinating the air-conditioning equipment to perform feedback control through calculating a coordinating factor for coordinating and correcting individual operating quantities based on deviations between state setting values, estimated by the state estimating portion, and state measured values, measured by the sensors, for calculating coordinated operating quantities through correcting the individual operating quantities, obtained from the operating quantity calculating portion, by the coordinating factor, and for sending, to the air-conditioning system, the individual coordinated operating quantities thus obtained.

In this case, the feedback controlling step may calculate a new operating quantity corresponding to a deviation based on air-conditioning control characteristics, set in advance, that indicate the relationship between a deviation and an operating quantity difference, and calculates, as the coordinating factor, a factor for converting the operating quantity to the new operating quantity.

Moreover, the feedback controlling step may calculate an individual coordinating factors for each individual sensor, and calculates the coordinating factor that is shared by each of the sensors through performing a statistical process on the individual factors.

Given the examples of the present invention, excellent responsiveness can be obtained even when controlling the air-conditioning environment in a specific location within the space using the disputed system heat flow analysis technique. Moreover, this makes it possible to perform feedback control wherein the air-conditioned air is coordinated for each of the blowing apertures, without greatly disrupting the balance of the operating quantities for the conditioned air that is blown out from the individual blowing apertures, thereby enabling excellent stability.

### BRIEF DESCRIPTION OF THE DRAWINGS

FIG. 1 is a block diagram illustrating a structure of an air conditioning controlling device according to a an example.

FIG. 2 is an explanatory diagram illustrating an example of a structure for an air-conditioning system.

FIG. 3 is a flow chart illustrating the air conditioning controlling operation in the air conditioning controlling device.

FIG. 4 is a flowchart illustrating the air-conditioning controlling procedure according to the example.

FIG. 5 is an example of calculating an individual deviation.

FIG. 6 is an example of calculating coordinated operating quantities.

FIG. 7 is a graph illustrating the changes in the coordinating factor over time.

FIG. 8 is a graph illustrating the changes in the coordinated airflow rates over time.

FIG. 9 is a graph illustrating the changes in the measured temperatures over time.

FIG. 10 is a graph illustrating the changes in the target location temperatures over time.

FIG. 11 is an example of calculating the coordinated operating quantities in another example.

FIG. 12 is an example of calculating the individual deviations in a further example.

FIG. 13 is an example of calculating the coordinated operating quantities in the further example.

### DETAILED DESCRIPTION

Examples for carrying out the present invention are explained next in reference to the figures.

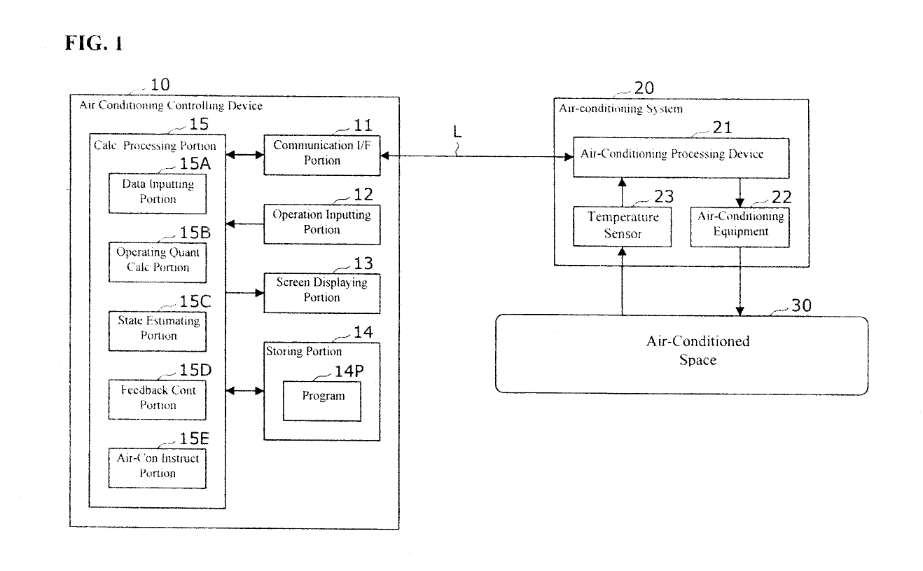

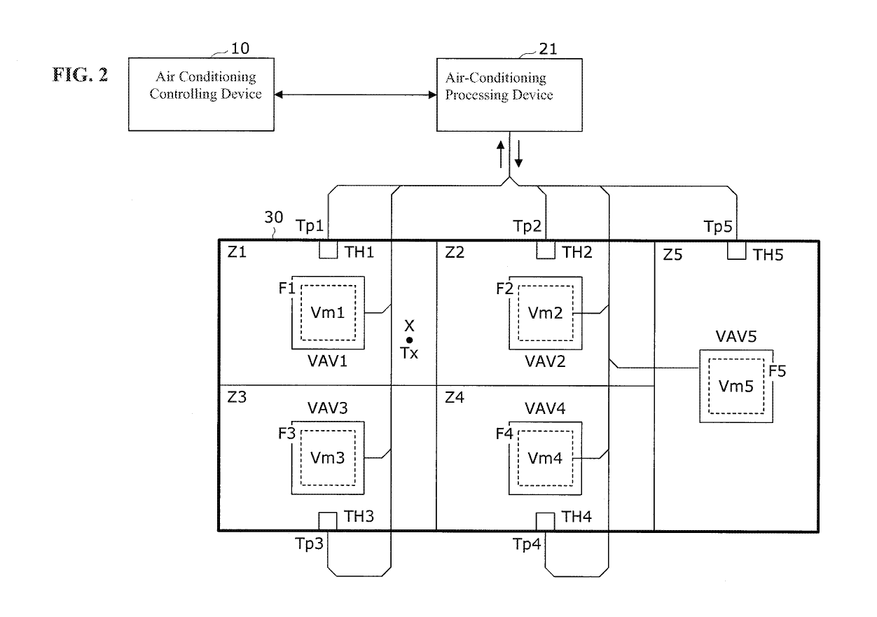

First of all, an air conditioning controlling device according to a an example or the present invention is explained in reference to FIG. 1 and FIG. 2. FIG. 1 is a block diagram illustrating a structure of an air conditioning controlling device according to an example. FIG. 2 is an explanatory diagram illustrating an example of a structure for an air-conditioning system.

The air conditioning controlling device 10 includes, overall, an information processing device such as a personal computer or a server, and has a function for controlling the air conditioning environment at a target location X of the air-conditioned space 30 through controlling an air conditioning system 20.

As the primary structure thereof, the air-conditioning system 20 is provided with an air-conditioning processing device 21, air-conditioning equipment 22, and temperature sensors 23.

The air-conditioning processing device 21 is structured, as a whole, from an information processing device such as a personal computer, a server device, or the like, and has a function for controlling the air-conditioning environment of the air-conditioned space 30, based on operating quantities sent through communication lines L from the air-conditioning controlling device 10, and a function for measuring temperatures within the air-conditioned space 30, using the temperature sensors 23, and for providing instructions to the air-conditioning controlling device 10 through the communication lines L.

In the example in FIG. 2, the air-conditioned space 30 is partitioned into five zones, zones Z1 through Z5. As the air-conditioning equipment 22, in these zones Z1 through Z5, VAV1 through VAV5 are provided in the respective blowing apertures F1 through F5 that are provided in the ceilings of the respective zones Z1 through Z5, and, as the temperature sensors 23, TH1 through TH5 are equipped on the walls of the respective zones. These zones Z1 through Z5 are not explicitly partitioned as spaces by walls, but rather the conditioned air that is blown out from the respective VAV1 through VAV5 flows back and forth therebetween. Because of this, this is a situation wherein there are thermal interferences between the zones.

VAV1 through VAV5 have a function for regulating the controlled air that is provided from the air conditioner (not shown) and for blowing it into the respective corresponding zones Z1 through Z5 from the individual blowing apertures F1 through F5 based on operating quantities such as the blowing airflow rates Vm1 through Vm5 as instructed by the air-conditioning controlling device 10 through the air-conditioning processing device 21.

TH1 through TH5 have a function for measuring, and sending to the air-conditioning processing device 21, the room temperatures Tp1 through Tp5 within the respective corresponding zones Z1 through Z5.

Performing CFD reverse analysis on the setting temperature distribution that is generated anew from the temperature distribution and the target temperatures at the target locations within the air-conditioned space 30 makes it possible to estimate the respective operating quantities for the conditioned air that is blown from the individual blowing apertures to cause the air-conditioned space 30 to go to the setting temperature distribution. The operating quantities thus obtained are static operating quantities for maintaining the setting temperature distribution, and thus the arrival time for the temperature distribution of the air-conditioned space to arrive at the setting temperature distribution is long.

Typically, feedback control is used in order to shorten the time required for arrival at the setting value. Feedback control is a controlling method wherein a difference from a previous operating quantity, that is, an operating quantity difference, corresponding to a deviation between a setting value and a measured value, is calculated based on control characteristics that have been set in advance, to control an object based on the operating quantity difference.

For example, in PID control, which is the most common form of feedback control, control characteristics are used wherein the operating quantity differences are calculated through a combination of three components pertaining to deviation: a proportional component (P), an integral component (I), and a differential component (D). When the coefficient relating to the proportional component is defined as Kp, the coefficient relating to the integral component is defined as Ki, and the coefficient relating to the differential component is defined as Kd, then the operating difference relating to the deviation can be calculated through Equation (1), below:

Operating Quantity Difference=Kp×deviation+Ki×cumulative value for the deviation+Kd×difference from the previous deviation (1)

Consequently, performing this type of feedback control for each of these zones Z1 through Z5, as illustrated in FIG. 2, described above, for example, makes it possible to reduce the time until the temperature distribution in the air-conditioned space 30 arrives at the setting temperature distribution. In practice, the temperatures of the zones Z1 through Z5 are measured by the temperature sensors TH1 through TH5, and thus the setting temperatures must be for the locations of these temperature sensors TH1 through TH5. In this regard, CFD forward analysis of the operating quantities makes it possible to calculate the setting temperatures at the locations of these temperature sensors TH1 through TH5.

When controlling the conditioned air from the individual blowing apertures independently for the individual zones by calculating the operating quantities in accordance with the deviations between the setting temperatures and the measured temperatures in an attempt to cause the measured temperatures, measured by the temperature sensors TH1 through TH5 in the zones Z1 through Z5, to go to the setting temperatures, there will be interferences between the zones. Because of this, even if the room temperatures at the temperature sensors in the individual zones were to arrive at the setting temperatures, this does not necessarily mean that the room temperatures at the target locations within the air-conditioned space 30 have arrived at the target temperatures. This is because there are many different combinations of operating quantities by which to cause the temperatures at the temperature sensors of the individual zones to reach the setting temperatures.

Consequently, for the temperatures at the target locations to arrive at the target temperatures it is necessary to adjust the feedback control in the individual zones. Focusing on the fact that the room temperature at a target location is unlikely to deviate from the target temperature when there is little change in the interferences between zones, the examples of the present invention perform corrections by coordinating the new operating quantities of the individual zones so that there will be little change in the interferences between the zones, that is, so that there will be no large disruption in the balance between the operating quantities for the conditioned air in the individual zones.

The examples of the present invention introduce a coordinating factor in order to make corrections by coordinating the operating quantities, and a calculating equation for calculating coordinated operating quantities, wherein the operating quantities are corrected, is defined using, as parameters, the operating quantities pertaining to the conditioned air in each zone and the coordinating factor. For this calculating equation, there are a variety of different methods for the calculations, such as a method for calculating the coordinated operating quantities through multiplying the operating quantities by the coordinating factor, and a method for multiplying the coordinating factor by adjustment widths that are set for the operating quantities and then adding the results to the operating quantities.

When it comes to the method for calculating the coordinating factor, for the operating quantities calculated using the distributed system fluid forward analysis, distributed system fluid reverse analysis may then be performed to estimate state setting values representing the state of the air-conditioning environment at the measurement locations of the sensors that are provided in the individual zones, to calculate new operating quantities, corresponding to the deviations between the state setting values thus obtained and the state measured values obtained from the sensors, based on the air-conditioning control characteristics that have been set in advance, to calculate, as the coordinating factor, a factor that that will convert the original operating quantities to the new operating quantities.

Based on this principle of the examples of the present invention, the air-conditioning controlling device 10 according to the example performs CFD reverse analysis on the air-conditioning environment of the air-conditioned space 30 to calculate, for each air-conditioning equipment 22, operating quantities for controlling the air-conditioned space 30 to the target air-conditioning environment, and then performs CFD reverse analysis on the operating quantities thus obtained to estimate state setting values that indicate the state of the target air-conditioning environment at the measurement positions for the individual sensors in the air-conditioned space 30, to calculate the coordinating factor for coordinating and correcting the individual operating quantities based on the deviations between the state setting values thus obtained and the state measured values that have been measured by the sensors, to calculate coordinated operating quantities through correcting the individual operating quantities through the coordinating factor, to thus perform coordinated feedback control of the air-conditioning equipment 22 through sending to the air-conditioning system 20 the individual coordinated operating quantities that have been obtained.

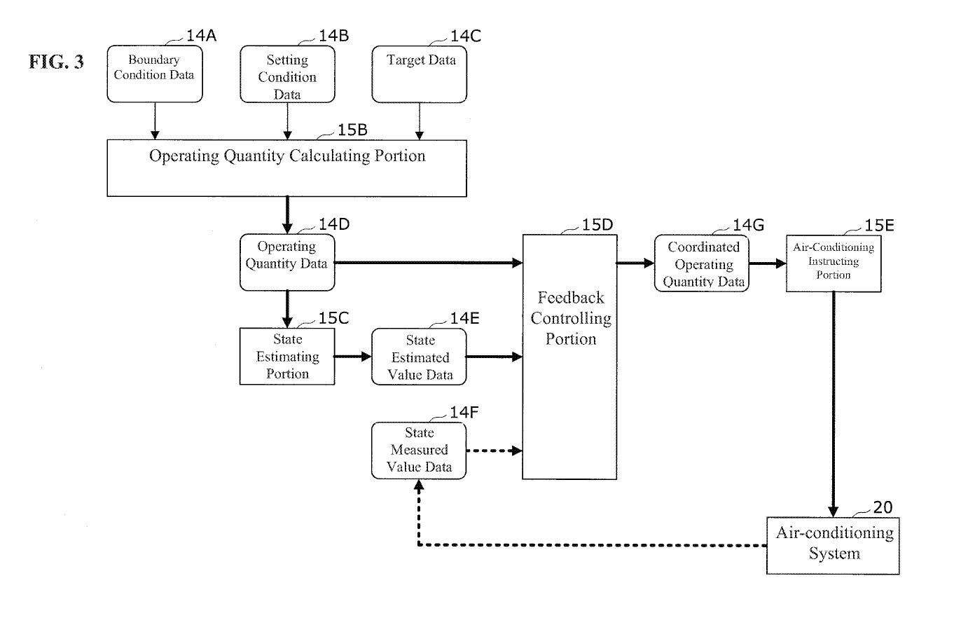

FIG. 1 and FIG. 3 are referenced next to explain in detail the air conditioning controlling device 10 according to the present example. FIG. 3 is a flow chart illustrating the air conditioning controlling operation in the air conditioning controlling device.

This air conditioning controlling device 10 is provided with a communication I/F portion (hereinafter termed the communication I/F portion) 11, an operation inputting portion 12, a screen displaying portion 13, a storing portion 14, and a calculation processing portion 15, as the primary functional components thereof.

The communication I/F portion 11 is made from a dedicated data communication circuit, and has the function of performing data communication with external devices, such as the air conditioning system, connected through a communication line L.

The operation inputting portion 12 is made from an operation inputting device, such as a keyboard or a mouse, and has a function for detecting operations by an operator and outputting them to the calculation processing portion 15.

The screen displaying portion 13 is made from a screen displaying device such as an LCD or a PDP, and has a function for displaying, on a screen, various types of information, such as an operating menu and input/output data, in accordance with instructions from the calculation processing portion 15.

The storing portion 14 is made from a storage device, such as a hard disk or a semiconductor memory, and has a function for storing various types of processing data and a program 14P used by the calculation processing portion 15.

The program 14P is a program that is read out and executed by the calculation processing portion 15, and is stored in advance into the storing portion 14 through the communication I/F portion 11 from an external device or recording medium.

The calculation processing portion 15 has a microprocessor, such as a CPU and the peripheral circuitry thereof, and has the function of embodying a variety of processing portions through reading in and executed the program 14P from the storing portion 14.

As the primary processing portions that are embodied in the calculation processing portion 15 there are a data inputting portion 15A, an operating quantity calculating portion 15B, a state estimating portion 15C, a feedback controlling portion 15D, and an air-conditioning instructing portion 15E.

The data inputting portion 15A has a function for storing in advance, into the storing portion 14, the various types of processing information that is used by the calculation processing portion 15, inputted through the communication I/F portion 11 from an external recording medium or device such as the air-conditioning system 20.

The operating quantity calculating portion 15D has a function for estimating the air-conditioning environment, such as the overall temperature distribution in the air-conditioned space 30, through performing CFD reverse analysis on boundary condition data 14A and setting condition data 14B, obtained through the data inputting portion 15A, and a function for performing CFD reverse analysis on the air-conditioning environment obtained through the CFD forward analysis and on the target data 14C obtained through the data inputting portion 15A, to calculate, for each individual air-conditioning equipment 22, the operating quantity for controlling the air-conditioned space 30 to the target air-conditioning environment, to be outputted as operating quantity data 14D.

The distributed system flow analysis technique is a technique for calculating, through numerical calculations, the distributions of temperature, air flow rates, and the like, from boundary conditions based on CFD (computational fluid dynamics). In a typical CFD, the space of interest is divided into a mesh of element spaces, and the heat flow between adjacent element spaces is analyzed.

The CFD forward analysis in the operating quantity calculating portion 15B is a technology for calculating the air-conditioning environment, such as the temperature distribution or airflow rate distribution, or the like, within the air-conditioned space 30 from the boundary condition data 14A and setting condition data 14B for the air-conditioned space 30 using this distributed system flow analysis technique, and, specifically, may use the known technology in KATO, Shinsuke; KOBAYASHI, Hikaru; and, MURAKAMI, Shuzo: “Scales for Assessing Contribution of Heat Sources and Sinks to Temperature Distributions in Room by Means of Numerical Simulation,” Institute of Industrial Science, University of Tokyo, Air-Conditioning and Sanitation Engineering Reports No. 69, pp. 36 to 47, April 1998.

On the other hand, the CFD reverse analysis in the operating quantity calculating portion 15B is a technique for calculating the final operating quantity for achieving the target air-conditioning environment through adjusting the operating quantities through the magnitudes of the sensitivities by calculating sensitivities (or contributions) of equipment relative to the locations for which a desired air-conditioning environment is to be achieved, and, specifically, may use known technologies such as in KATO, Shinsuke; KOBAYASHI, Hikaru; and, MURAKAMI, Shuzo: “Scales for Assessing Contribution of Heat Sources and Sinks to Temperature Distributions in Room by Means of Numerical Simulation,” Institute of Industrial Science, University of Tokyo, Air-Conditioning and Sanitation Engineering Reports No. 69, pp. 36 to 47, April 1998 or ABE, Kohei; MOMOSE, Kazunari; and KIMOTO, Hideo, “Optimization of Natural Convection Field Using Adjoint Numerical Analysis,” Transactions of the Japan Society of Mechanical Engineers. B, Vol. 70; No. 691; Page. 729-736 (March 2004).

The boundary condition data 14A is data indicating the magnitude of effects on the air-conditioning environment of the air-conditioned space 30, where magnitudes of effects that are manifested in the airflow rates, airflow directions, and temperatures, are recorded as boundary conditions at the applicable points in time for each individual structural element wherein the effects on the air-conditioning environment of the air-conditioned space 30 change. This boundary condition data 14A includes data indicating the controlled state of the conditioned air in the air-conditioning system 20, such as the blowing airflow rates and blowing temperatures, and the like, of the conditioned air that is blown from each individual air-conditioning equipment 22, obtained from the air-conditioning system 20 through the data inputting portion 15A.

The setting condition data 14B includes various types of data that form the setting conditions when performing the heat flow analysis processes, such as spatial condition data that represent locations and shapes pertaining to the structural elements that have an impact on the air conditioning environment of the air-conditioned space 30, such as locations and shapes pertaining to the air-conditioned space 30, conditioned air blowing vents formed in the air conditioning system 20, and the like, along with, for example, heat-producing object data that indicate the layout position, amount of heat produced, and shape of each heat-producing object that is disposed in the air-conditioned space 30.

The target data 14C is data indicating the target temperatures Txs at target locations X within the air-conditioned space 30.

The operating quantity data 14D are data indicating the operating quantities for each of the air-conditioning equipment 22 in order to control the air-conditioned space 30 to the target air-conditioning environment.

The state estimating portion 15C has a function for estimating, and outputting as state estimated value data 14E, the respective state setting values that indicate the state of the air-conditioning environment at the measurement locations of the individual sensors that are equipped in the air-conditioned space 30, through performing CFD forward analysis on the various operating quantities included in the operating quantity data 14D obtained from the operating quantity calculating portion 15B.

The CFD forward analysis in the state estimating portion 15C is the same technology as the CFD forward analysis in the operating quantity calculating portion 15B, and, specifically, may use a known technology such as in KATO, Shinsuke; KOBAYASHI, Hikaru; and, MURAKAMI, Shuzo: “Scales for Assessing Contribution of Heat Sources and Sinks to Temperature Distributions in Room by Means of Numerical Simulation,” Institute of Industrial Science, University of Tokyo, Air-Conditioning and Sanitation Engineering Reports No. 69, pp. 36 to 47, April 1998.

The feedback controlling portion 15D has a function for calculating a coordinating factor for making corrections by coordinating the individual operating quantities based on deviations between the state setting values that are included in the state estimated value data 14E obtained by the state estimating portion 15C and the state measured values that are measured by the individual sensors, included in the state measured value data 14F from the air-conditioning system 20, a function for calculating coordinated operating quantities through correcting, through the coordinating factor, the individual operating quantities obtained from the operating quantity calculating portion 15B, and a function for coordinating the air-conditioning equipment 22 to perform feedback control through sending, from the air-conditioning instructing portion 15E, to the air-conditioning system 20, the coordinated operating quantity data 14G that includes the individual coordinated operating quantities that have been obtained.

The air-conditioning instructing portion 15E has a function for sending, to the air-conditioning system 20, through the communication I/F portion 11, the coordinated operating quantities that are included in the coordinated operating quantity data 14G from the feedback controlling portion 15D.

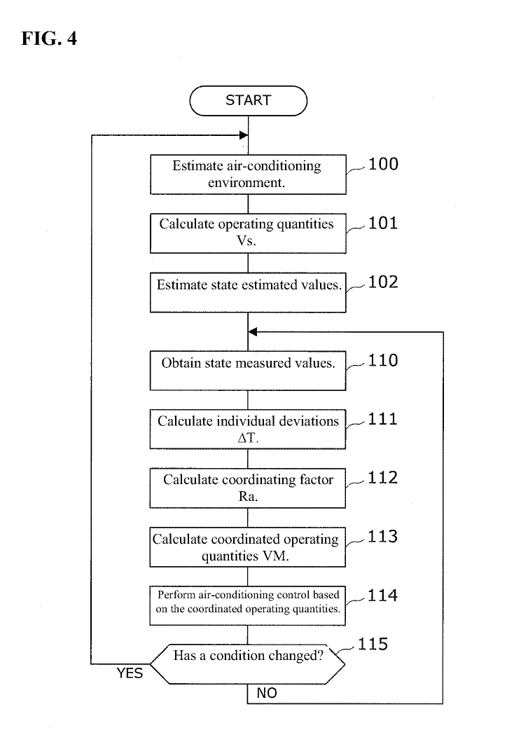

The operation of the air conditioning controlling device 10 according to the present form of embodiment will be explained next in reference to FIG. 4. FIG. 4 is a flowchart illustrating the air-conditioning controlling process in a first form of embodiment.

The calculation processing portion 15 of the air conditioning controlling device 10 begins the air conditioning controlling process of FIG. 4 at the time of startup or in response to an operator operation. Note that prior to the start of execution of the air-conditioning controlling processes, the boundary condition data 14A and the setting condition data 14B are stored in advance in the storing portion 14. Here the explanation is for a case wherein the temperature within the air-conditioned space 30 is controlled through manipulating the airflow rates of the conditioned air that is blown out from the individual air-conditioning equipment 22.

First, the operating quantity calculating portion 15B estimates the air-conditioning environment of the air-conditioned space 30 as a whole through performing CFD forward analysis after reading out, from the storing portion 14, the boundary condition data 14A and the setting condition data 14B obtained from the data inputting portion 15A (Step 100).

Following this, the operating quantity calculating portion 15B performs CFD reverse analysis on the air-conditioning environment that was estimated through the CFD forward analysis and on the target data 14C that indicates the target temperatures Txs at the target locations X of the air-conditioned space 30, to calculate, and output as operating quantity data 14D, the airflow rates Vsi of each of the air-conditioning equipment 22, as operating quantities for the individual air-conditioning equipment 22, for controlling the air-conditioned space to the target air-conditioning environment (Step 101).

Following this, the state estimating portion 15C performs CFD forward analysis on the individual airflow rates Vs that are included in the operating quantity data 14D that has been obtained from the operating quantity calculating portion 15B, to estimate the respective setting temperatures Ts at the measuring positions of the individual temperature sensors 23 that are equipped in the air-conditioned space 30, to output these as the state estimated value data 14E (Step 102). At this time, the state estimating portion 15C references the boundary condition data 14A and the setting condition data 14B as necessary.

Thereafter, the data inputting portion 15A obtains, from the air-conditioning system 20, the measured temperatures Tp measured by the individual temperature sensors 23, and stores these into the storing portion 14 as the state measured value data 14F (Step 110).

Following this, the feedback controlling portion 15D calculates the individual deviations ΔT at the temperature sensors 23 from the setting temperatures Ts that are included in the state estimated value data 14E from the state estimating portion 15C and the measured temperatures Tp from the temperature sensors 23, included in the state measured value data 14F that is read out from the storing portion 14 (Step 111).

At this time, for each temperature sensor 23, the individual deviation ΔT is calculated from the setting temperature Tsi of the temperature sensor THi, estimated by the state estimating portion 15C, and the measured temperature Tpi measured by the temperature sensor THi, as the individual deviation ΔTi=Tsi−Tpi.

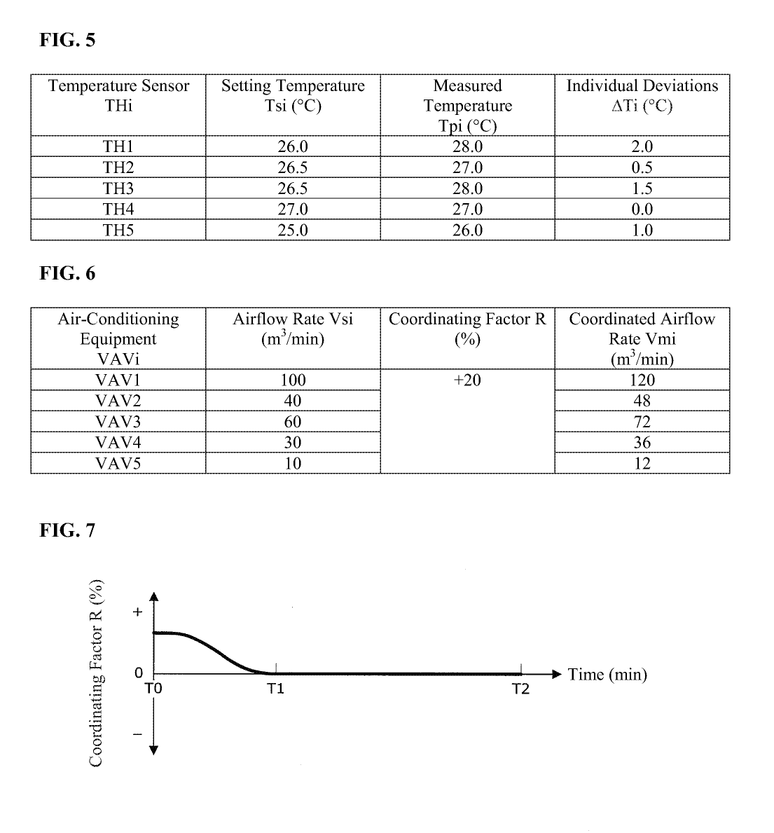

FIG. 5 is an example of calculating an individual deviation in a first form of embodiment. Here the setting temperatures Tsi (° C.) at the measurement locations of the temperature sensors TH1 through TH5 are, respectively, 26.0, 26.5, 26.5, 27.0, and 25.0, where the measured temperatures Tp (° C.) by the temperature sensors TH1 through TH5 are, respectively, 28.0, 27.0, 28.0, 27.0, and 26.0. Consequently, the individual deviations ΔTi (° C.) at the temperature sensors TH1 through TH5 are, respectively, 2.0, 0.5, 1.5, 0.0, and 1.0.

After this, the feedback controlling portion 15D calculates the coordinating factor Ra for coordinating and correcting the individual operating quantities based on the individual deviations ΔTi calculated in this way (Step 112).

The method for calculating the coordinating factor Ra is to calculate the individual factors Ri corresponding to these individual deviations ΔTi, and then calculating the coordinating factor Ra through performing statistical processing on these individual factors Ri.

At this time, the individual factors Ri are calculated through calculating the new operating quantities Vni corresponding to the individual deviations ΔTi based on the air-conditioning control characteristics indicated by the relationship between deviations and difference in operating quantities, set in advance, and then calculating, as the individual factors Ri, the factors for converting into the new operating quantities Vni the operating quantities Vsi that were obtained by the operating quantity calculating portion 15B.

At this time, as the statistical process, a process such as the calculation of an average value, the calculation of a median value, the selection of a maximum value or a minimum value, or the like, may be used. Moreover, as the statistical process, a process for selecting, as a coordinating factor Ra, the individual factor Ri of the temperature sensor THi that is the nearest or the furthest from a target location X may be performed.

Note that the method for calculating the individual factors Ri is dependent on the calculation equation for calculating the coordinated operating quantity Vm from the operating quantity Vs through the coordinating factor Ra. For example, when calculating a coordinated operating quantity Vmi by adding to an operating quantity Vsi a difference operating quantity obtained by multiplying the operating quantity Vsi by the coordinating factor Ra, the individual factor Ri is calculated through subtracting from 1 the new operating quantity Vni divided by the operating quantity Vsi. Specifically, in the case of an operating quantity Vsi=100 (m³/min) and the new operating quantity Vni=120 (m³/min), then the individual factor Ri would be Ri=1−Vni/Vsi=1−120/100=20%.

Thereafter, the feedback controlling portion 15D corrects each of the [unintelligible typographical error—perhaps “setting”?] operating quantities Vs that have been estimated by the state estimating portion 15C, by the coordinating factor Ra calculated as described above, to calculate each of the coordinated operating quantities Vm, to be outputted as the coordinated operating quantity data 14G (Step 113).

FIG. 6 is an example of calculating coordinated operating quantities in the example. Here the airflow rates Vsi (m³/min) that are the operating quantities for the air-conditioning equipment VAV-1 through VAV5 are, respectively, 100, 40, 60, 30, and 10. Consequently, in the case of the coordinating factor Ra=20%, from the example described above, then the coordinated airflow rates Vmi (m³/min) that are the coordinated operating quantities for the air-conditioning equipment VAV1 through VAV5 are calculated as, for example, Vmi=Vsi×(1+Ra), to be, respectively, 120, 48, 72, 36, and 12.

Following this, the air-conditioning instructing portion 15E instructs the air-conditioning system 20, through the communication I/F portion 11, to perform air-conditioning estimated control for controlling the air-conditioning environment of the air-conditioned space 30 as a whole based on the coordinated operating quantities obtained by the feedback controlling portion 15D (Step 114).

Thereafter, if the boundary condition data 14A, the setting condition data 14B, or the target data 14C has been updated (Step 115: YES), then the feedback controlling portion 15D returns to Step 100 in order to recalculate the operating quantities Vs and the setting temperatures Ts.

On the other hand, if there has been no update to the boundary condition data 14A, the setting condition data 14B, or the target data 14C (Step 115: NO), then processing returns to Step 110 in order to calculate the coordinated operating quantities Vn in accordance with the new measured temperatures Tp.

The operation of the air conditioning controlling device 10 according to the present example is explained next.

FIG. 7 is a graph illustrating the changes in the coordinating factor over time, wherein the horizontal axis shows the time (minutes) and the vertical axis shows the coordinating factor Ra (%). In this example, a relatively large coordinating factor value appears at the time mark T0 wherein air-conditioning control is started, and thereafter, in the interval up until time mark T1, it falls to zero, indicating that corrections are not needed, and thereafter, it is constant at zero until time mark T2.

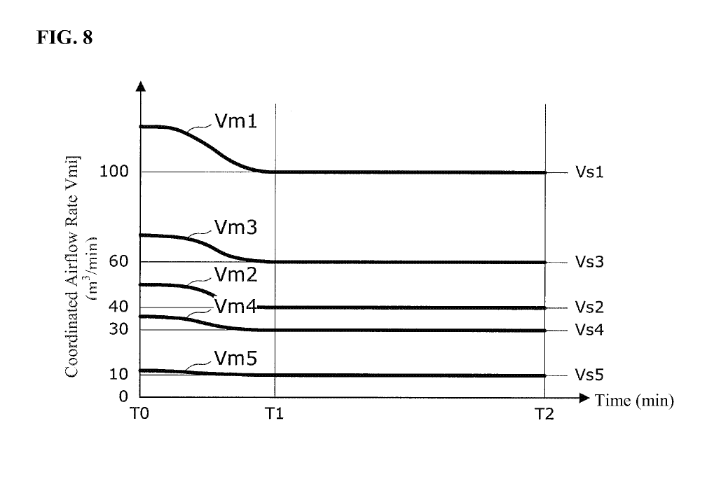

FIG. 8 is a graph illustrating changes over time in the coordinated airflow rates, wherein the horizontal axis shows the time (minutes) and the vertical axis shows the coordinated airflow rates V (m3/min) corresponding to the coordinated operating quantities. Here the changes are shown for the coordinated airflow rates Vm1 through Vm5, corresponding to the air-conditioning equipment VAV1 through VAV5, when feedback control has been performed applied to the present form of embodiment. For the coordinated airflow rates Vm1 through Vm5, relatively large operating quantities appear at time mark T0 wherein the air-conditioning control is started, and thereafter, in the interval up until the time mark T1, they fall to the original airflow rates Vs1 through Vs5, and are constant thereafter until time mark T2. These coordinated airflow rates Vm1 through Vm5 can be seen to change coordinated together with each other, rather than increasing or decreasing individually.

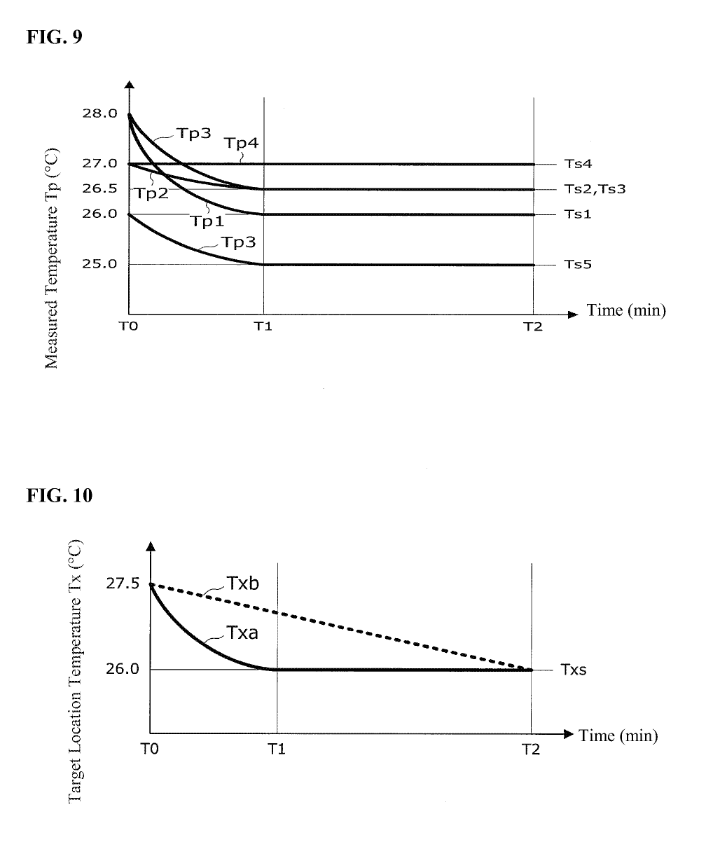

FIG. 9 is a graph illustrating the changes in the measured temperatures over time, wherein the horizontal axis indicates the time (minutes) and the vertical axis indicates the measured temperatures Tp (° C.). Here the changes in the measured temperatures Tp1 through Tp5 at the temperature sensors TH1 through TH5 are shown for the case wherein feedback control is performed applied to the present example. The measured temperatures Tp1 through Tp5 indicate respectively the measured temperatures Tpi, shown in FIG. 5, at the time mark T0 at the beginning of air-conditioning control, where, thereafter, the setting temperatures Ts1 through Ts5 each transition slowly in the interval up to the time mark T1, and thereafter are constant until the time mark T2.

FIG. 10 is a graph illustrating the changes in the target location temperatures over time, wherein the horizontal axis indicates the time (minutes) and the vertical axis indicates the target location temperature Tx (° C.). Here the change in the target location temperature Txa at the target location X when feedback control is performed, applied to the present form of embodiment, and the target location temperature Txb at the target location X when the airflow rates of the individual air-conditioning equipment VAV1 through VAV5 are held constant at the airflow rates Vs1 through Vs5 are shown.

The target location temperature Txa (° C.) indicates an initial value of 27.5 at the time mark T0 at the start of the air-conditioning control, and thereafter gradually transitions to a target temperature of 26.0 during the interval up to the time mark T1, after which it is constant until the time mark T2. On the other hand, the target location temperature Txb (° C.) shows an initial value of 27.5 at the time mark T0 at the start of air-conditioning control, and then first arrives at the target temperature of 26.0 at the time mark T2, which is after the time mark T1.

Consequently, when feedback control is performed applied to the present form of embodiment, the time for arriving at the target temperature is shortened from the time mark T2 to the time mark T1.

In the present example, the operating quantity calculating portion 15B performing CFD reverse analysis on the air-conditioning environment of the air-conditioned space 30 in this way calculates, for each air-conditioning equipment 22, an operating quantity for controlling the air-conditioned space 30 to the target air-conditioning environment, and the CFD forward analysis on these operating quantities, by the state estimating portion 15C estimates each of the respective state setting values that indicate the state of the target air-conditioning environment at the measurement positions of each of the sensors in the air-conditioned space 30.

Given this, the coordinating factor for coordinating and correcting each of the operating quantities is calculated in the feedback controlling portion 15D based on the deviation between the state setting values that have been obtained and the state measured values that have been measured by the sensors, where coordinated operating quantities are calculated through correcting the individual operating quantities by the coordinating factor, and each of the coordinated operating quantities that have been obtained is sent to the air-conditioning system 20, to thereby perform feedback control that causes the air-conditioning equipment 22 to operate in coordination.

Doing this makes it possible to reduce the overall time for the air-conditioned space 30 to arrive at the target air-conditioning environment after the commencement of air-conditioning control. This enables excellent responsiveness even in the case of calculating, through distributed system flow analysis, the operating quantities for controlling the conditioned space 30 to the target air-conditioning environment. Moreover, this makes it possible to perform feedback control, by coordinating the conditioned air for each blowing aperture, without greatly disrupting the balance of the operating quantities regarding the conditioned air that is blown out of the individual blowing apertures of the separate air-conditioning equipment 22, thus enabling greater stability.

Moreover, while, in the present example, the explanation was for a case of controlling the temperature distribution in the air-conditioning environment of the air-conditioned space 20, in the air-conditioning controlling device 10, there is no limitation thereto, but rather similar effects of operation can be claimed through the ability to perform identical control for an air-conditioning environment other than the temperature within the air-conditioned space 20, such as the airflow speed, humidity, CO₂, or the like, through the use of sensors that detect the statuses thereof, rather than using the temperature sensor 23.

An air conditioning controlling device 10 according to another example of the present invention is explained next.

In the above example, a case wherein, when calculating the coordinated operating quantities in the feedback controlling portion 15D, difference operating quantities obtained through multiplying a coordinating factor Ra with the operating quantities Vs were added to the operating quantities Vs to calculate the coordinated operating quantities Vm was explained as an example. In the present example, a case wherein adjustment widths Vw, which have been assigned in advance, are multiplied by the coordinating factor Ra and added to the operating quantities Vs to calculate the coordinated operating quantities Vm is explained.

In the present example, the feedback controlling portion 15D has a function for calculating, for an operating quantity Vs, an adjustment width Vw through multiplying an adjustment ratio Rw that is set in advance.

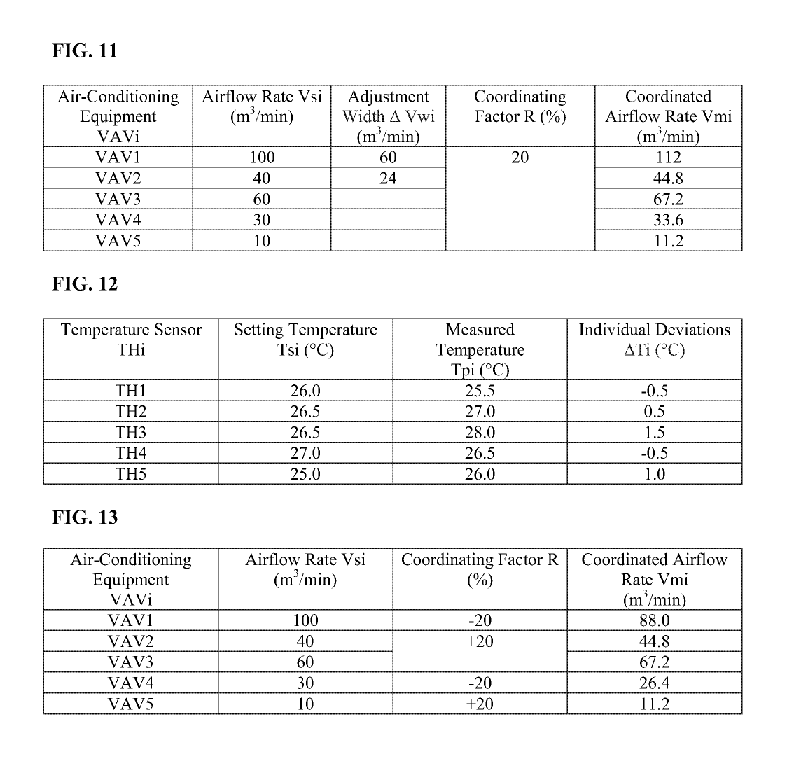

FIG. 11 is an example of calculating coordinated operating quantities in the example. Here the airflow rates Vs (m³/min) that are the operating quantities for the air-conditioning equipment VAV-1 through VAV5 are, respectively, 100, 40, 60, 30, and 10. Consequently, for an adjustment ratio Rw=60% (±30%), the adjustment widths Vwi (m³/min) in relation to the air-conditioning equipment VAV1 through VAV5 are calculated as Vwi=Vsi×Rw, to be, respectively, 60, 24, 36, 18, and 6.

Consequently, in the case of the coordinating factor Ra=20%, the coordinated airflow rates Vmi (m³/min) that are the coordinated operating quantities for the air-conditioning equipment VAV1 through VAV5 are calculated as, for example, Vmi=Vsi+Vwi×Ra, to be, respectively, 112, 44.8, 67.2, 33.6, and 11.2.

Here, in the present example, the coordinated operating quantities Vm were calculated through adding, to the operating quantities Vs, values wherein adjustment widths Vw, assigned in advance, were multiplied by the coordinating factor Ra, and thus it is possible to limit changes in the coordinated operating quantities Vm to the adjustment widths Vw, thereby providing high stability.

An air conditioning controlling device 10 according to a further example of the present invention explained next.

In the above examples, a case was explained wherein operating quantities for the conditioned air that is blown out from each of the individual blowing apertures were adjusted so as to each change in the same direction, for the temperatures at the locations of the individual temperature sensors 23 when calculating the coordinated operating quantities in the feedback controlling portion 15D.

However, there are cases wherein it is necessary to adjust the operating quantity in the downward direction for the temperature at the location of the operating sensor TH1 and to adjust the operating quantity for the temperature in the upward direction for the location of the temperature sensor TH2.

In the present example, a case is explained wherein, in the feedback controlling portion 15D, if the temperatures are to be adjusted in their own individual directions at the locations of each of the individual temperature sensors 23, the increase or decrease in the operating quantity Vs through the coordinating factor Ra is determined in accordance with the polarity of the individual deviation ΔTi at the location of the respective temperature sensor 23. Note that while the case that is explained below is an example of application to the calculation method for the coordinated airflow rates according to the above example, there is no limitation thereto, but rather it can be applied similarly to other methods of calculating coordinated airflow rates, such as the method for calculating the coordinated airflow rates according to the examples.

FIG. 12 is an example of calculating the individual deviations according to the further example. As with the above examples, in the feedback controlling portion 15D the individual deviations ΔTi between the setting temperatures Tsi for the applicable temperature sensors THi, estimated by the state estimating portion 15C, and the measured temperatures Tpi, measured by the applicable temperature sensors THi, as individual deviation ΔTi=Tsi−Tpi, for each of the temperature sensors 23, and a representative deviation ΔT is calculated through statistical processing of these individual deviations ΔTi.

In the example in FIG. 12, the setting temperatures Tsi (° C.) for the measurement locations of the temperature sensors TH1 through TH5 are, respectively, 26.0, 26.5, 26.5, 27.0, and 25.0, where the measured temperatures Tpi (° C.) by the temperature sensors TH1 through TH5 are, respectively, 25.5, 27.0, 28.0, 26.5, and 26.0. In this case, the individual deviations ΔTi (° C.) at the temperature sensors TH1 through TH5 are, respectively, −0.5, 0.5, 1.5, −0.5, and 1.0.

Following this, the feedback controlling portion 15D, based on the air-conditioning controlling characteristics, set in advance, that indicate the relationships between the temperature deviations and the operating quantity differences for the conditioned air, calculates a coordinating factor Ra corresponding to the aforementioned representative deviation ΔT. In this case, the coordinating factor Ra relating to the air-conditioning equipment VAV1 through VAV5 is given the polarity of the individual deviations ΔTi at the corresponding temperature sensors TH1 through TH5.

FIG. 13 is an example of calculating coordinated operating quantities in this example. Here the airflow rates Vs (m³/min) that are the operating quantities for the air-conditioning equipment VAV1 through VAV5 are, respectively, 100, 40, 60, 30, and 10. Here, in the case of the coordinating factor Ra calculated from the individual deviations ΔTi based on the air-conditioning controlling characteristics being Ra=20%, the coordinating factors Rai (%) relating to the air-conditioning equipment VAV1 through VAV5, based on the polarity of the individual deviations ΔTi at the corresponding temperature sensors TH1 through TH5, will be −20, +20, +20, −20, and +20.

Consequently, if the coordinating factor Ra is 20%, then the coordinated airflow rates Vmi (m³/min) that are the coordinated operating quantities for the air-conditioning equipment VAV1 through VAV5 are calculated by, for example, Vmi=Vsi×(1+Ra), to be, respectively, 88.0, 44.8, 67.2, 26.4, and 11.2.

In this way, in the present example, the increase or decrease of the operating quantity Vs by the coordinating factor Ra is determined in accordance with the polarity of the individual deviation ΔTi at the location of the respective temperature sensor 23, thus making it possible to adjust in the respective individual direction the temperature at the location of the temperature sensor 23, thus enabling highly precise control of the temperature at the target location to the target temperature.

While the present invention was explained above in reference to examples, the present invention is not limited by the examples set forth above. The structures and details of the present invention may be modified in a variety of ways, as can be understood by those skilled in the art, within the scope of the present invention.

1. An air-conditioning controlling device sending to an air-conditioning system, which controls air-conditioning equipment that is provided in an air-conditioned space, operating quantities for the air-conditioning equipment, to control the air-conditioned space to an arbitrary air-conditioning environment, comprising:
an operating quantity calculating portion calculating, for each individual air-conditioning equipment, an operating quantity controlling the air-conditioned space to the target air-conditioning environment, through performing distributed system flow analysis of the air-conditioning environment within the air-conditioned space based on condition data that indicate the structure of the air-conditioned space and effects on the air-conditioning environment within the air-conditioned space, and target data that indicate a target value at a target location within the air-conditioned space under the target air-conditioning environment;
a state estimating portion estimating respective state setting values that indicate the state of the target air-conditioning environment in the measurement locations of the individual sensors that are provided within the air-conditioned space, through distributed system flow forward analysis of the operating quantities obtained by the state estimating portion; and
a feedback controlling portion coordinating the air-conditioning equipment to perform feedback control through calculating a coordinating factor coordinating and correcting individual operating quantities based on deviations between state setting values, estimated by the state estimating portion, and state measured values, measured by the sensors, calculating coordinated operating quantities through correcting the individual operating quantities, obtained from the operating quantity calculating portion, by the coordinating factor, and sending, to the air-conditioning system, the individual coordinated operating quantities thus obtained.

2. The air conditioning controlling device as set forth in claim 1, wherein:
the feedback controlling portion calculates a new operating quantity corresponding to a deviation based on air-conditioning control characteristics, set in advance, that indicate the relationship between a deviation and an operating quantity difference, and calculates, as the coordinating factor, a factor for converting the operating quantity to the new operating quantity.

3. The air conditioning controlling device as set forth in claim 2, wherein:
the feedback controlling portion calculates an individual coordinating factors for each individual sensor, and calculates the coordinating factor that is shared by each of the sensors through performing a statistical process on the individual factors.

4. An air-conditioning controlling method for sending to an air-conditioning system, which controls air-conditioning equipment that is provided in an air-conditioned space, operating quantities for the air-conditioning equipment, to control the air-conditioned space to an arbitrary air-conditioning environment, wherein:
an operating quantity calculating portion has an operating quantity calculating step calculating, for each individual air-conditioning equipment, an operating quantity for controlling the air-conditioned space to the target air-conditioning environment, through performing distributed system flow analysis of the air-conditioning environment within the air-conditioned space based on condition data that indicate the structure of the air-conditioned space and effects on the air-conditioning environment within the air-conditioned space, and target data that indicate a target value at a target location within the air-conditioned space under the target air-conditioning environment;
a state estimating portion has a state estimating step estimating respective state setting values that indicate the state of the target air-conditioning environment in the measurement locations of the individual sensors that are provided within the air-conditioned space, through distributed system flow forward analysis of the operating quantities obtained by the state estimating portion; and
a feedback controlling portion has a feedback controlling step coordinating the air-conditioning equipment to perform feedback control through calculating a coordinating factor coordinating and correcting individual operating quantities based on deviations between state setting values, estimated by the state estimating portion, and state measured values, measured by the sensors, for calculating coordinated operating quantities through correcting the individual operating quantities, obtained from the operating quantity calculating portion, by the coordinating factor, and sending, to the air-conditioning system, the individual coordinated operating quantities thus obtained.

5. The air conditioning controlling method as set forth in claim 4, wherein:
the feedback controlling step calculates a new operating quantity corresponding to a deviation based on air-conditioning control characteristics, set in advance, that indicate the relationship between a deviation and an operating quantity difference, and calculates, as the coordinating factor, a factor for converting the operating quantity to the new operating quantity.

6. The air conditioning controlling method as set forth in claim 5, wherein:
the feedback controlling step calculates an individual coordinating factors for each individual sensor, and calculates the coordinating factor that is shared by each of the sensors through performing a statistical process on the individual factors.
